(19) United States
(12) Patent Application Publication
(10) Pub. No.: US 2022/0064556 A1
(43) Pub. Date: Mar. 3, 2022

(54) METHODS AND SYSTEMS FOR PROCESSING CRUDE OIL

(71) Applicant: Saudi Arabian Oil Company, Dhahran (SA)

(72) Inventors: Aaron Chi Akah, Dhahran (SA); Qi Xu, Dhahran (SA); Musaed Salem Al-Ghrami, Dhahran (SA)

(73) Assignee: Saudi Arabian Oil Company, Dhahran, SAUDI ARABIA

(21) Appl. No.: 17/009,076

(22) Filed: Sep. 1, 2020

(51) Int. Cl. C10G 69/14; B01J 19/24

(52) U.S. Cl. CPC C10G 69/14; B01J 19/2445; C10G 2400/20; C10G 2400/30; B01J 2219/00038; C10G 2300/4006; C10G 2300/4012; C10G 2300/308; C10G 2300/301

(57) ABSTRACT

A feed stream including crude oil may be processed by a method that includes separating the feed stream into at least a C₁ hydrocarbon fraction, a C₂-C₄ hydrocarbon fraction, and a C₅₊ hydrocarbon fraction. The method may further include methane cracking at least a portion of the C₁ hydrocarbon fraction to form a methane cracked product, steam cracking at least a portion of the C₂-C₄ hydrocarbon fraction to form a steam cracked product, and steam enhanced catalytically cracking at least a portion of the C₅₊ hydrocarbon fraction to form a steam enhanced catalytically cracked product. The method may further include passing at least a portion of the steam cracked product and at least a portion of the steam enhanced catalytically cracked product to a product separator to produce one or more product streams. Systems for processing a feed stream comprising crude oil are further described herein.

### TECHNICAL FIELD

Embodiments of the present disclosure generally relate to chemical processing and, more specifically, to methods and systems for processing crude oil into aromatics and/or light olefins.

### BACKGROUND

Olefins and aromatic compounds, such as ethylene, propylene, butylene, butadiene, benzene, toluene, and xylenes, are basic intermediates for many petrochemical industries. These olefins and aromatic compounds are usually obtained through the thermal cracking (or steam pyrolysis) of petroleum gases and distillates such as naphtha, kerosene, or gas oil. These compounds are also produced through refinery fluidized catalytic cracking (FCC) process where standard heavy feedstocks, such as gas oils or residues, are converted. Typical FCC feedstocks range from hydrocracked bottoms to heavy feed fractions, such as vacuum gas oil and atmospheric residue. However, these feedstocks are limited. Another source for propylene production is currently refinery propylene from FCC units. With the ever-growing demand, FCC unit owners look increasingly to the petrochemicals market to boost their revenues by taking advantage of economic opportunities that arise in the propylene market.

The worldwide increasing demand for light olefins remains a major challenge for many integrated refineries. In particular, the production of some valuable light olefins such as ethylene, propylene, and butylene has attracted increased attention as pure olefin streams are considered the building blocks for polymer synthesis. The production of light olefins depends on several process variables like the feed type, operating conditions, and the type of catalyst.

### SUMMARY

Despite the options available for producing a greater yield of propylene and other light olefins, intense research activity in this field is still being conducted. It is desirable to produce light olefins and/or benzene, toluene, and xylenes (BTX) directly from a crude oil source. However, such methods are problematic since crude oils contain heavy components that may interfere with, for example, standard steam or catalytic cracking procedures. The present disclosure is directed to methods and systems for producing light olefins (e.g., C₂-C₄ olefins) and/or BTX from crude oils by separating the crude oil source, such as light crude oils, into at least three fractions, which are separately processed.

According to one or more embodiments, a method for processing a feed stream comprising crude oil may include separating the feed stream into at least a C₁ hydrocarbon fraction, a C₂-C₄ hydrocarbon fraction, and a C₅₊ hydrocarbon fraction. The method may further include methane cracking at least a portion of the C₁ hydrocarbon fraction to form a methane cracked product comprising hydrogen. The method may further include steam cracking at least a portion of the C₂-C₄ hydrocarbon fraction to form a steam cracked product comprising C₂-C₄ olefins. The method may further include steam enhanced catalytically cracking at least a portion of the C₅₊ hydrocarbon fraction to form a steam enhanced catalytically cracked product comprising olefins, benzene, toluene, xylene, naphtha, or combinations thereof. The method may further include passing at least a portion of the steam cracked product and at least a portion of the steam enhanced catalytically cracked product to a product separator to produce one or more product streams. Such a method produces enhanced yields of light olefins and/or BTX when compared to some known systems.

According to one or more additional embodiments, a system for processing a feed stream comprising crude oil may include a separator configured to separate the crude oil into at least a C₁ hydrocarbon fraction, a C₂-C₄ hydrocarbon fraction, and a C₅₊ hydrocarbon fraction. The system may further include a methane cracking zone fluidly coupled to the separator and configured to crack at least a portion of the C₁ hydrocarbon fraction. The system may further include a steam cracking zone fluidly coupled to the separator and configured to crack at least a portion of the C₂-C₄ hydrocarbon fraction to form a steam cracked product. The system may further include a steam enhanced catalytic cracking system fluidly coupled to the separator and configured to crack at least a portion of the a C₅₊ hydrocarbon fraction to form a steam enhanced catalytically cracked product. The system may further include a product separator fluidly coupled to at least the steam cracking zone and steam enhanced catalytic cracking system, and configured to separate at least a portion of the steam cracked product and at least a portion of the catalytically cracked product into one or more product streams. Such a system produces enhanced yields of light olefins, BTX hydrocarbons, and/or fuel oil when compared to some known systems.

Additional features and advantages of the described embodiments will be set forth in the detailed description, which follows, and in part will be readily apparent to those skilled in the art from that description or recognized by practicing the described embodiments, including the detailed description, which follows, the claims, as well as the appended drawings.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 is a generalized schematic diagram of a hydrocarbon conversion system, according to one or more embodiments described in this disclosure;

FIG. 2 is a generalized schematic diagram of a hydrocarbon conversion system, according to one or more additional embodiments described in this disclosure;

FIG. 3 schematically depicts a generalized schematic diagram of a steam cracking zone, according to one or more embodiments described in this disclosure;

FIG. 4 schematically depicts a generalized flow diagram of a steam enhanced catalytic cracking system, according to one or more embodiments shown and described in this disclosure; and

FIG. 5 schematically depicts a generalized flow diagram of a methane cracking zone, according to one or more embodiments shown and described in this disclosure.

For the purpose of describing the simplified schematic illustrations and descriptions of the relevant figures, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not depicted. Accompanying components that are in hydrocracking units, such as bleed streams, spent catalyst discharge subsystems, and catalyst replacement sub-systems are also not shown. It should be understood that these components are within the spirit and scope of the present embodiments disclosed. However, operational components, such as those described in the present disclosure, may be added to the embodiments described in this disclosure.

It should further be noted that arrows in the drawings refer to process streams. However, the arrows may equivalently refer to transfer lines, which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows, which do not connect two or more system components, signify a product stream, which exits the depicted system, or a system inlet stream, which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

It should be understood that according to the embodiments presented in the relevant figures, an arrow between two system components may signify that the stream is not processed between the two system components. In other embodiments, the stream signified by the arrow may have substantially the same composition throughout its transport between the two system components. Additionally, it should be understood that in one or more embodiments, an arrow may represent that at least 75 wt. %, at least 90 wt. %, at least 95 wt. %, at least 99 wt. %, at least 99.9 wt. %, or even 100 wt. % of the stream is transported between the system components. As such, in some embodiments, less than all of the stream signified by an arrow may be transported between the system components, such as if a slip stream is present.

It should be understood that two or more process streams are “mixed” or “combined” when two or more lines intersect in the schematic flow diagrams of the relevant figures. Mixing or combining may also include mixing by directly introducing both streams into a like reactor, separation device, or other system component. For example, it should be understood that when two streams are depicted as being combined directly prior to entering a separation unit or reactor, that in some embodiments the streams could equivalently be introduced into the separation unit or reactor and be mixed in the reactor. Alternatively, when two streams are depicted to independently enter a system component, they may in some embodiments be mixed together before entering that system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

One or more embodiments of the present disclosure are directed to methods and systems for converting one or more feed streams that include crude oil into one or more petrochemical products, such as olefins and/or aromatics. In general, a feed stream including crude oil may be separated into at least three fractions of different compositions based on boiling point of the fraction, referred to herein as the C₁ hydrocarbon fraction, the C₂-C₄ hydrocarbon fraction, and the C₅₊ hydrocarbon fraction. According to embodiments, the C₁ hydrocarbon fraction may be methane cracked, the C₂-C₄ hydrocarbon fraction may be steam cracked, and the C₅₊ hydrocarbon fraction may be steam enhanced catalytically cracked.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous stirred-tank reactor (CSTR), or a plug flow reactor. Exemplary reactors include packed bed reactors such as fixed bed reactors, and fluidized bed reactors. One or more “reaction zones” may be disposed in a reactor. As used in this disclosure, a “reaction zone” refers to an area where a particular reaction takes place in a reactor. For example, a packed bed reactor with multiple catalyst beds may have multiple reaction zones, where each reaction zone is defined by the area of each catalyst bed.

As used in this disclosure, a “separation unit” refers to any separation device that at least partially separates one or more chemicals that are mixed in a process stream from one another. For example, a separation unit may selectively separate differing chemical species, phases, or sized material from one another, forming one or more chemical fractions. Examples of separation units include, without limitation, distillation columns, flash drums, knock-out drums, knock-out pots, centrifuges, cyclones, filtration devices, traps, scrubbers, expansion devices, membranes, solvent extraction devices, and the like. It should be understood that separation processes described in this disclosure may not completely separate all of one chemical constituent from all of another chemical constituent. It should be understood that the separation processes described in this disclosure “at least partially” separate different chemical components from one another, and that even if not explicitly stated, it should be understood that separation may include only partial separation. As used in this disclosure, one or more chemical constituents may be “separated” from a process stream to form a new process stream. Generally, a process stream may enter a separation unit and be divided, or separated, into two or more process streams of desired composition. Further, in some separation processes, a “lower boiling point fraction” (sometimes referred to as a “light fraction”) and a “higher boiling point fraction” (sometimes referred to as a “heavy fraction”) may exit the separation unit, where, on average, the contents of the lower boiling point fraction stream have a lower boiling point than the higher boiling point fraction stream. Other streams may fall between the lower boiling point fraction and the higher boiling point fraction, such as a “medium boiling point fraction.”

It should be understood that an “effluent” generally refers to a stream that exits a system component such as a separation unit, a reactor, or reaction zone, following a particular reaction or separation, and generally has a different composition (at least proportionally) than the stream that entered the separation unit, reactor, or reaction zone.

As used in this disclosure, a “catalyst” refers to any substance that increases the rate of a specific chemical reaction. Catalysts described in this disclosure may be utilized to promote various reactions, such as, but not limited to, cracking (including aromatic cracking), demetalization, desulfurization, and denitrogenation. As used in this disclosure, “cracking” generally refers to a chemical reaction where carbon-carbon bonds are broken. For example, a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

As used in this disclosure, the term “spent catalyst” refers to catalyst that has been introduced to and passed through a cracking reaction zone to crack a crude oil, such as the higher boiling point fraction or the lower boiling point fraction for example, but has not been regenerated in the regenerator following introduction to the cracking reaction zone. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration.

As used in this disclosure, the term “regenerated catalyst” refers to catalyst that has been introduced to a cracking reaction zone and then regenerated in a regenerator to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both compared to spent catalyst and may have greater catalytic activity compared to spent catalyst. The “regenerated catalyst” may have more coke and lower catalytic activity compared to fresh catalyst that has not passed through a cracking reaction zone and regenerator.

It should further be understood that streams may be named for the components of the stream, and the component for which the stream is named may be the major component of the stream (such as comprising from 50 weight percent (wt. %), from 70 wt. %, from 90 wt. %, from 95 wt. %, from 99 wt. %, from 99.5 wt. %, or even from 99.9 wt. % of the contents of the stream to 100 wt. % of the contents of the stream). It should also be understood that components of a stream are disclosed as passing from one system component to another when a stream comprising that component is disclosed as passing from that system component to another. For example, a disclosed “propylene stream” passing from a first system component to a second system component should be understood to equivalently disclose “propylene” passing from a first system component to a second system component, and the like.

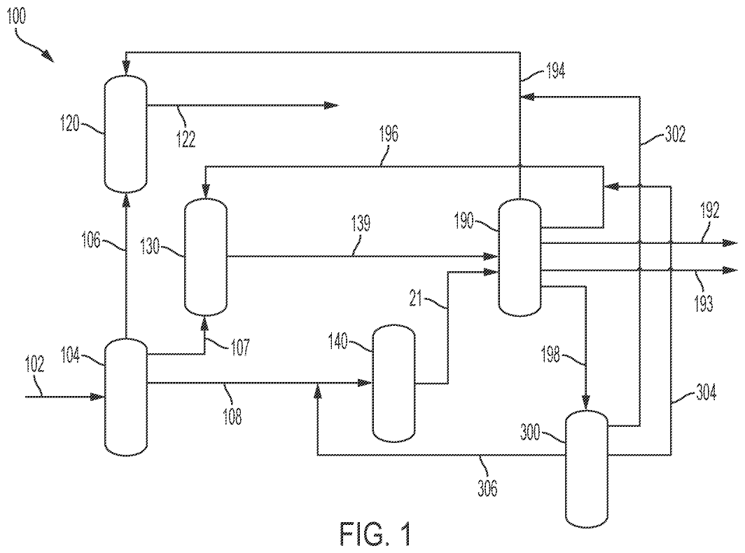

Referring to FIG. 1, the feed stream 102 includes crude oil, and description of the feed stream may be descriptive of the crude oil therein. In embodiments, the feed stream may be crude oil. As used in this disclosure, the term “crude oil” is to be understood to mean a mixture of petroleum liquids, gases, or combinations of liquids and gases, including some impurities such as sulfur-containing compounds, nitrogen-containing compounds and metal compounds that has not undergone significant separation or reaction processes. Crude oils are distinguished from fractions of crude oil. In certain embodiments the crude oil feedstock may be a minimally treated light crude oil to provide a crude oil feedstock having total metals (Nickel+Vanadium) content of less than 5 parts per million by weight (ppmw) and Conradson carbon residue of less than 5 wt. % Such minimally treated materials may be considered crude oils as described herein.

While the present description and examples may specify crude oil as the feed stream 102, it should be understood that the feed stream conversion systems 100 described with respect to the embodiments of FIG. 1, may be applicable for the conversion of a wide variety of crude oils, which may be present in the feed stream 102, including, but not limited to, crude oil, vacuum residue, tar sands, bitumen, atmospheric residue, vacuum gas oils, demetalized oils, naphtha streams, other hydrocarbon streams, or combinations of these materials. The feed stream 102 may include one or more non-hydrocarbon constituents, such as one or more heavy metals, sulfur compounds, nitrogen compounds, inorganic components, or other non-hydrocarbon compounds. If the feed stream 102 is crude oil, it may be a light crude oil, which includes crude oil having an American Petroleum Institute (API) gravity of greater than 35°, 36°, 37°, or 38°. In such embodiments, the light crude oil may be categorized as a sour light crude oil, which includes crude oil having a sulfur content of less than 1.5 weight percent (wt. %), based on the total weight of the crude oil, such as less than or equal to 1.4 wt. %, 1.3 wt. %, 1.2 wt. %, 1.1 wt. %, or 1.0 wt. %. For example, the feed stream 102 may be Arab Extra Light crude oil, which has an API gravity of approximately 39° and a sulfur content of approximately 1.1 wt. %. It should be understood that, as used in this disclosure, a “feed stream” may refer to crude oil, which has not been previously treated, separated, or otherwise refined.

In general, the contents of the feed stream 102 may include a relatively wide variety of chemical species based on boiling point. For example, the feed stream 102 may have composition such that the difference between the 5 wt. % boiling point and the 95 wt. % boiling point of the feed stream 102 is at least 100° C., at least 200° C., at least 300° C., at least 400° C., at least 500° C., or even at least 600° C.

Referring still to FIG. 1, the feed stream 102 may be introduced to the feed separator 104, which may separate the contents of the feed stream 102 into at least a C₁ hydrocarbon fraction 106, a C₂-C₄ hydrocarbon fraction 107, and a C₅₊ hydrocarbon fraction 108. In one or more embodiments, at least 90 wt. %, at least 95 wt. %, at least 99 wt. %, or even at least 99.9 wt. % of the feed stream 102 may be present in the combination of the C₁ hydrocarbon fraction 106, the C₂-C₄ hydrocarbon fraction 107, and the C₅₊ hydrocarbon fraction 108. In one or more embodiments, the feed separator 104 may be series of vapor-liquid separators such as a flash drums (sometimes referred to as a breakpot, knock-out drum, knock-out pot, compressor suction drum, or compressor inlet drum). The vapor-liquid separators may be operated at a temperature and pressure suitable to separate the feed stream 102 into the C₁ hydrocarbon fraction 106, the C₂-C₄ hydrocarbon fraction 107, and the C₅₊ hydrocarbon fraction 108. It should be understood that a wide variety of fractionating separators may be utilized, such as distillation columns and the like.

In one or more embodiments, the C₁ hydrocarbon fraction 106 may generally include methane. In embodiments, the components of C₁ hydrocarbon fraction 106 may be the lightest components of the feed stream 102.

In one or more embodiments, the C₂-C₄ hydrocarbon fraction 107 may generally include C₂-C₄ hydrocarbons, such as ethane, propane, butane, ethylene, propylene, butylene, ethyne, propyne, butyne, or combinations thereof.

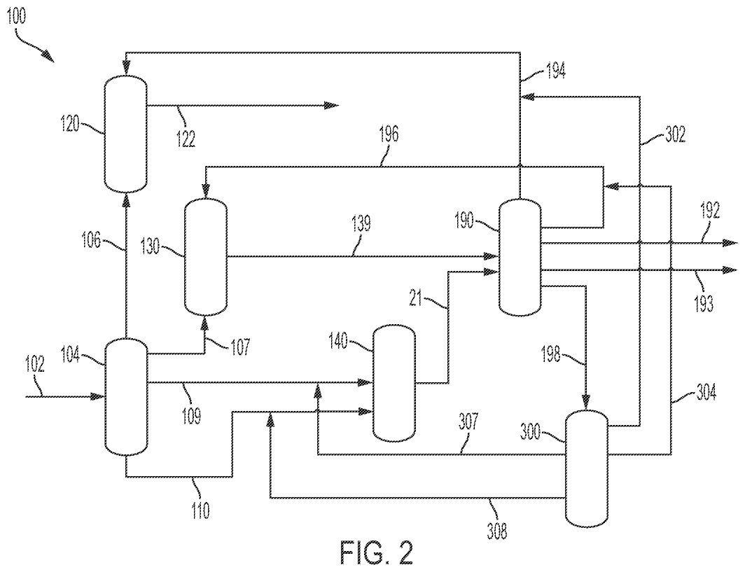

In one or more embodiments, the C₅₊ hydrocarbon fraction 108 may generally include C₅₊ hydrocarbons. As shown in FIG. 2, the C₅₊ hydrocarbon fraction 108 may include a lower boiling point fraction 109 and a higher boiling point fraction 110. The lower boiling point fraction 109 may include C₅₊ hydrocarbons having a T₉₅ boiling point (that is, the temperature at which greater than 95% of components are boiling in a hydrocarbon composition) of less than 300° C. The higher boiling point fraction 110 may include C₅₊ hydrocarbons having a T₅ boiling point (that is, the temperature at which less than 5% of components are boiling in a hydrocarbon composition) of greater than or equal to 300° C. As such, in embodiments, a temperature cut between the lower boiling point fraction 109 and the higher boiling point fraction 110 may be 300° C. It should be understood, however, that in other embodiments, the temperature cut may be above or below 300° C. depending upon the components in the feed stream 102. The T₉₅ boiling point of the higher boiling point fraction 110 may generally be dependent upon the boiling point of the heaviest components of the feed stream 102, and may be, for example, at least 600° C., or even at least 650° C. In some embodiments, the T₉₅ boiling point of the lower boiling point fraction 109 may be equal to the T₅ boiling point of the higher boiling point fraction 110.

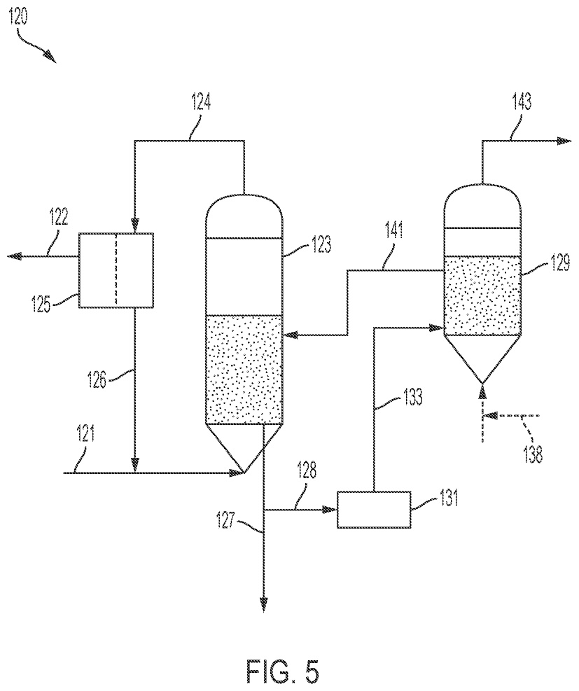

According to one or more embodiments, the C₁ hydrocarbon fraction 106 may be passed from the separator 104 to a methane cracking zone 120. According to embodiments, the methane cracking zone 120 may be a methane cracking zone unit that is not integrated with the separator 104. However, in embodiments, the methane cracking zone 120 may be integrated into the separator 104. The methane cracking zone 120 may be operated at a temperature of from 850° C. to 1200° C. and at a pressure of from 1 bar to 2 bar. The methane cracking zone 120 may produce a methane cracked product 122, including hydrogen. As shown in FIG. 5, a natural gas stream 121 may be introduced to a fluidized bed reactor 123 over fine carbon particles. A stream 124 including a mixture of H₂ and unconverted CH₄ exits the fluidized bed reactor 123 and passes through cyclones (not shown) that remove a majority of entrained carbon particulates present in the unconverted CH₄. The stream 124 is then introduced to a gas separation unit 125 (e.g., a polymeric gas separation membrane) where pure hydrogen is separated as the methane cracked product 122 from methane and other gases, which may be recycled to the fluidized bed reactor 123 via stream 126.

Without being bound by theory, directly cracking the C₁ hydrocarbon fraction 106 with the methane cracking zone 120 may produce carbon monoxide-free hydrogen, which may be incorporated in applications requiring pure hydrogen (e.g., fuel cells). In contrast, typical systems produce hydrogen primarily through catalytic steam reforming, partial oxidation, and auto-thermal reforming of natural gas. Although these processes are mature technologies, carbon monoxide is often formed as a byproduct, and, as such, must be eliminated from a hydrogen (H₂) stream through complicated and costly separation processes. Moreover, the methane cracking zone 120 produces a pure, pulverulent carbon as byproduct stream 127, which is a useful industrial raw material in the production of elastomers, lightweight construction materials, printing inks, and batteries. A portion of carbon particles 128 (approximately 20% to 30%) are introduced to a heater 129 via grinder 131. Heater 129 provides heat to the methane cracking zone 120 by burning a fraction of carbon 133 that has been introduced to the heater 129. Alternatively, heat for the methane cracking zone 120 may be provided by introducing and combusting of portion of natural gas or other non-permeate gas 138 within the heater 129. Hot carbon particles 141 from the heater 129 may then be re-introduced into the fluidized bed reactor 123. One or more stack gases 143 may also be recovered from the heater 129. A jet attrition system (not shown) may be present in the fluidized bed reactor 123 to provide additional seed carbon particles to maintain a constant particle size within the methane cracking zone 120.

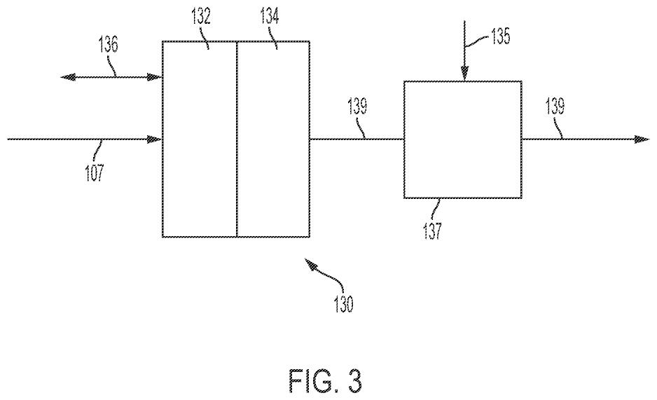

According to one or more embodiments, the C₂-C₄ hydrocarbon fraction 107 may be passed from the separator 104 to a steam cracking zone 130. Now referring to FIG. 3, a steam cracking system is depicted that is representative of the steam cracking zone 130 of FIGS. 1 and 2. The steam cracking zone 130 may include a convection zone 132 and a pyrolysis zone 134. The C₂-C₄ hydrocarbon fraction 107 may pass into the convection zone 132 along with steam 136. In the convection zone 132, the C₂-C₄ hydrocarbon fraction 107 may be pre-heated to a desired temperature, such as from 400° C. to 650° C. The contents of the C₂-C₄ hydrocarbon fraction 107 present in the convection zone 132 may then be passed to the pyrolysis zone 134 where it is steam-cracked. The steam cracked product 139 may exit the steam cracking zone 130 and optionally be passed through a heat exchanger 137 where process fluid 135, such as water or pyrolysis fuel oil, cools the steam cracked product 139. The steam cracked product 139 may include a mixture of cracked hydrocarbon-based materials, which may be separated into one, or more petrochemical products included in product streams 192, 193. For example, the steam cracked product 139 may include C₂-C₄ olefins, and optionally, one or more of benzene, toluene, xylene, naphtha, fuel gas, butadiene, C₅₊ hydrocarbons, fuel oil, or combinations thereof.

According to one or more embodiments, the pyrolysis zone 134 of the steam cracking zone 130 may operate at a temperature of from 700° C. to 950° C., such as from 800° C. to 950° C. and at a pressure of from 1 bar to 2 bar. The pyrolysis zone 134 may operate with a residence time of from 0.05 seconds to 2 seconds. The mass ratio of steam 136 to the C₂-C₄ hydrocarbon fraction 107 may be from about 0.3:1 to about 2:1.

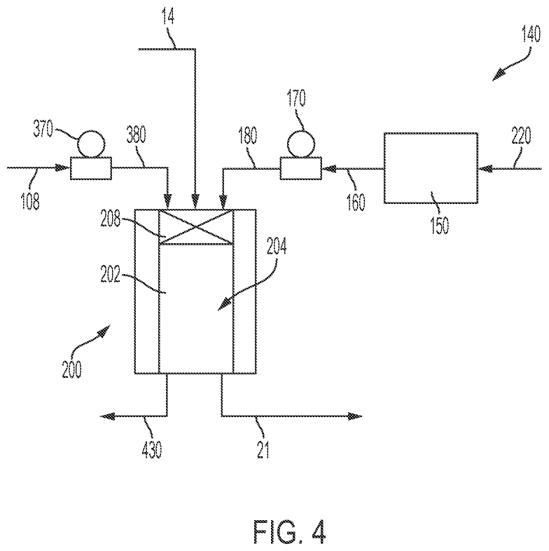

As is depicted in FIG. 1, the C₅₊ hydrocarbon fraction 108 may be passed from the feed separator 104 to a steam enhanced catalytic cracking system 140. Now referring to FIG. 4, an embodiment of a steam enhanced catalytic cracking system 140 is depicted. It should be understood that other configurations of steam enhanced catalytic cracking systems are contemplated for use in the system 100. The steam enhanced catalytic cracking system 140 may include one or a plurality of steam enhanced catalytic cracking reactors 200. The steam enhanced catalytic cracking reactor 200 may be a fixed bed catalytic cracking reactor that includes a cracking catalyst 202 disposed within a steam cracking catalyst zone 204. The steam enhanced catalytic cracking reactor 200 may include a porous packing material 208, such as silica carbide packing, upstream of the steam cracking catalyst zone 204. The porous packing material 208 may ensure sufficient heat transfer to the C₅₊ hydrocarbon fraction 108 and steam (generated from water stream 220) prior to conducting the steam enhanced catalytic cracking reaction in the steam cracking catalyst zone 204. Without being bound by theory, it is believed that a system that includes the steam enhanced catalytic cracking system 140 produces more light olefins compared systems that incorporate conventional fluid catalytic cracking (FCC) units. Typically, FCC units are set up mainly to upgrade heavy feeds to gasoline and other transportation fuels. Further, typical FCC units are not set up to handle large quantities of steam like those used in steam enhanced catalytic cracking. The present steam enhanced catalytic cracking system 140, however, may be more targeted to process the C₅₊ hydrocarbon fraction 108 in the presence of steam.

The cracking catalyst may be a nano-zeolite cracking catalyst comprising nano-zeolite particles. A variety of nano-zeolites may be suitable for the steam enhanced catalytic cracking reactions in the steam enhanced catalytic cracking reactor 200. The nano-zeolite cracking catalyst may include a structured zeolite, such as an MFI, a GIS, or a BEA structured zeolite, for example. In embodiments, the nano-zeolite cracking catalyst may comprise nano ZSM-5 zeolite, nano BEA zeolite, nano USY zeolite, combinations thereof. In one or more embodiments, the nano-zeolite cracking catalyst may be loaded with phosphorous and a combination of heavy metals (e.g., metals having a density of greater than 5 g/cm³), such as iron, lanthanum, cerium, zirconium, and combinations thereof. The nano-zeolites, such as nano-ZSM-5 zeolite, nano Beta zeolite, nano USY, or combinations thereof may be in hydrogen form. In hydrogen form, the Brønsted acid sites in the zeolite, also known as bridging OH—H groups, may form hydrogen bonds with other framework oxygen atoms in the zeolite framework.

The nano ZSM-5 zeolite, the nano Beta zeolite, the nano USY zeolite, or combinations thereof may have a molar ratio of silica to alumina to provide sufficient acidity to the nano-zeolite cracking catalyst to conduct the steam enhanced catalytic cracking reactions. The nano ZSM-5 zeolite, the nano Beta zeolite, the nano USY zeolite, or combinations thereof may have a molar ratio of silica to alumina of from 10 to 200, from 15 to 200, from 20 to 200, from 10 to 150, from 15 to 150, or from 20 to 150. The nano ZSM-5 zeolite, the nano Beta zeolite, the nano USY zeolite, or combinations thereof may have total acidity in the range of 0.2 millimoles/gram (mmol/g) to 2.5 mmol/g, 0.3 mmol/g to 2.5 mmol/g, 0.4 mmol/g to 2.5 mmol/g, 0.5 mmol/g to 2.5 mmol/g, 0.2 mmol/g to 2.0 mmol/g, 0.3 mmol/g to 2.0 mmol/g, 0.4 mmol/g to 2.0 mmol/g, or 0.5 mmol/g to 2.0 mmol/g. The nano ZSM-5 zeolite, the nano Beta zeolite, the nano USY zeolite, or combinations thereof may have an average crystal size of from 50 nanometer (nm) to 600 nm, from 60 nm to 600 nm, from 70 nm to 600 nm, from 80 nm to 600 nm, from 50 nm to 580 nm, or from 50 nm to 550 nm.

The nano-zeolite cracking catalyst may also include an alumina binder, which may be used to consolidate the nanoparticles of nano ZSM-5 zeolite, nano Beta zeolite, nano USY zeolite, or combinations thereof to form the nano-zeolite cracking catalyst. The nano-zeolite cracking catalyst may be prepared by combining the nano ZSM-5 zeolite, the nano Beta zeolite, the nano USY zeolite, or combinations thereof with the aluminum binder and extruding the nano-zeolite cracking catalyst to form pellets or other catalyst shapes. The nano-zeolite cracking catalyst may include from 10 weight percent (wt. %) to 80 wt. %, from 10 wt. % to 75 wt. %, from 10 wt. % to 70 wt. %, from 15 wt. % to 80 wt. %, from 15 wt. % to 75 wt. %, or from 15 wt. % to 70 wt. % alumina binder based on the total weight of the nano-zeolite cracking catalyst. The nano-zeolite cracking catalyst may have a mesoporous to microporous volume ratio in the range of from 0.5 to 1.5, from 0.6 to 1.5, from 0.7 to 1.5, from 0.5 to 1.0, from 0.6 to 1.0, or from 0.7 to 1.0.

Referring again to FIG. 4, the C₅₊ hydrocarbon fraction 108 may be introduced to the steam enhanced catalytic cracking reactor 200. The C₅₊ hydrocarbon fraction 108 may be heated to a temperature of from 35 degrees Celsius (° C.) to 150° C. and then introduced to a feed pump 370. In embodiments, the C₅₊ hydrocarbon fraction 108 may be heated from 40° C. to 150° C., from 45° C. to 150° C., from 50° C. to 150° C., from 35° C. to 145° C., from 40° C. to 145° C., from 45° C. to 145° C., from 35° C. to 140° C., from 40° C. to 140° C., or from 45° C. to 140° C. The flowrate of the feed pump 370 may be adjusted so that the C₅₊ hydrocarbon fraction 108 is injected into the steam enhanced catalytic cracking reactor 200 through line 380 at a gas hourly space velocity of greater than or equal to 0.1 per hour (h⁻¹) or greater than or equal to 0.25 h⁻¹. The C₅₊ hydrocarbon fraction 108 may be injected into the steam enhanced catalytic cracking reactor 200 at a gas hourly space velocity of less than or equal to 50 h⁻¹, less than or equal to 25 h⁻¹, less than or equal to 20 h⁻¹, less than or equal to 14 h⁻¹, less than or equal to 9 h⁻¹, or less than or equal to 5 h⁻¹. The C₅₊ hydrocarbon fraction 108 may be injected into the steam enhanced catalytic cracking reactor 200 at a gas hourly space velocity of from 0.1 h⁻¹ to 50 h⁻¹, from 0.1 h⁻¹ to 25 h⁻¹, from 0.1 h⁻¹ to 20 h⁻¹, from 0.1 h⁻¹ to 14 h⁻¹, from 0.1 h⁻¹ to 9 h⁻¹, from 0.1 h⁻¹ to 5 h⁻¹, from 0.1 h⁻¹ to 4 h⁻¹, from 0.25 h⁻¹ to 50 h⁻¹, from 0.25 h⁻¹ to 25 h⁻¹, from 0.25 h⁻¹ to 20 h⁻¹, from 0.25 h⁻¹ to 14 h⁻¹, from 0.25 h⁻¹ to 9 h⁻¹, from 0.25 h⁻¹ to 5 h⁻¹, from 0.25 h⁻¹ to 4 v, from 1 h⁻¹ to 50 h⁻¹, from 1 h⁻¹ to 25 h⁻¹, from 1 h⁻¹ to 20 h⁻¹, from 1 h⁻¹ to 14 h⁻¹, from 1 h⁻¹ to 9 h⁻¹, or from 1 h⁻¹ to 5 h⁻¹ via the preheated line 380. The C₅₊ hydrocarbon fraction 108 may be further pre-heated in the line 380 to a temperature from 100° C. to 250° C. before injecting the C₅₊ hydrocarbon fraction 108 into the steam enhanced catalytic cracking reactor 200.

Water 220 may be injected to the steam enhanced catalytic cracking reactor 200 through lines 160, 180 via the water feed pump 170. Prior to introducing the water 220 to the steam enhanced catalytic cracking reactor 200, the water 220 may be collected in a water tank 150. The water line 180 may be pre-heated at to a temperature of from 50° C. to 75° C., from 50° C. to 70° C., from 55° C. to 75° C., or from 55° C. to 70° C. The water 220 may be converted to steam in water line 180 or upon contacting with the C₅₊ hydrocarbon fraction 108 in the steam enhanced catalytic cracking reactor 200. The flowrate of the water feed pump 170 may be adjusted to deliver water 220 (liquid, steam, or both) to the steam enhanced catalytic cracking reactor 200 at a gas hourly space velocity of greater than or equal to 0.1 h⁻¹, greater than or equal to 0.5 h⁻¹, greater than or equal to 1 h⁻¹, greater than or equal to 5 h⁻¹, greater than or equal to 6 h⁻¹, greater than or equal to 10 h⁻¹, or even greater than or equal to 15 h⁻¹. The water 220 may be introduced to the steam enhanced catalytic cracking reactor 200 at a gas hourly space velocity of less than or equal to 100 h⁻¹, less than or equal to 75 h⁻¹, less than or equal to 50 h⁻¹, less than or equal to 30 h⁻¹, or less than or equal to 20 h⁻¹. The water 120 may be introduced to the steam enhanced catalytic cracking reactor 200 at a gas hourly space velocity of from 0.1 h⁻¹ to 100 h⁻¹, from 0.1 h⁻¹ to 75 h⁻¹, from 0.1 h⁻¹ to 50 h⁻¹, from 0.1 h⁻¹ to 30 h⁻¹, from 0.1 h⁻¹ to 20 h⁻¹, from 1 h⁻¹ to 100 h⁻¹, from 1 h⁻¹ to 75 h⁻¹, from 1 h⁻¹ to 50 h⁻¹, from 1 h⁻¹ to 30 h⁻¹, from 1 h⁻¹ to 20 h⁻¹, from 5 h⁻¹ to 100 h⁻¹, from 5 h⁻¹ to 75 h⁻¹, from 5 h⁻¹ to 50 h⁻¹, from 5 h⁻¹ to 30 h⁻¹, from 5 h⁻¹ to 20 h⁻¹, from 6 h⁻¹ to 100 h⁻¹, from 6 h⁻¹ to 75 h⁻¹, from 6 h⁻¹ to 50 h⁻¹, from 6 h⁻¹ to 30 h⁻¹, from 6 h⁻¹ to 20 h⁻¹, from 10 h⁻¹ to 100 h⁻¹, from 10 h⁻¹ to 75 h⁻¹, from 10 h⁻¹ to 50 h⁻¹, from 10 h⁻¹ to 30 h⁻¹, from 10 h⁻¹ to 20 h⁻¹, from 15 h⁻¹ to 100 h⁻¹, from 15 h⁻¹ to 75 h⁻¹, from 15 h⁻¹ to 50 h⁻¹, from 15 h⁻¹ to 30 h⁻¹, or from 15 h⁻¹ to 20 h⁻¹ via water line 180.

The steam from injection of the water 220 may reduce the hydrocarbon partial pressure, which may have the dual effects of increasing yields of light olefins as well as reducing coke formation. Light olefins like propylene and butylene are mainly generated from catalytic cracking reactions following the carbonium ion mechanism, and as these are intermediate products, they can undergo secondary reactions such as hydrogen transfer and aromatization (leading to coke formation). The steam may increase the yield of light olefins by suppressing these secondary bi-molecular reactions, and reduce the concentration of reactants and products, which favor selectivity towards light olefins. The steam may also suppress secondary reactions that are responsible for coke formation on catalyst surface, which is good for catalysts to maintain high average activation. These factors may show that a large steam-to-oil weight ratio may be beneficial to the production of light olefins.

The gas hourly space velocity of water 220 introduced to the steam enhanced catalytic cracking reactor 200 may be greater than the gas hourly space velocity of the C₅₊ hydrocarbon fraction 108 passed to the steam enhanced catalytic cracking reactor 200. A ratio of the flowrate (gas hourly space velocity) of steam or water 220 to the flowrate (gas hourly space velocity) of the C₅₊ hydrocarbon fraction 108 to the steam enhanced catalytic cracking reactor 200 may be from 2 to 10 times, from 2 to 8 times, 2 to 6, from 2 to 5.5, from 2 to 5, from 3 to 6, from 3 to 5.5, or from 3 to 5 to improve the steam enhanced catalytic cracking process in the presence of the nano-zeolite cracking catalyst.

Referring still to FIG. 4, the steam enhanced catalytic cracking reactor 200 may be operable to contact the C₅₊ hydrocarbon fraction 108 with steam (from water 220) in the presence of the cracking catalyst—such as, in embodiments, the catalysts disclosed above—under reaction conditions sufficient cause at least a portion of the hydrocarbons from the C₅₊ hydrocarbon fraction 108 to undergo one or more cracking reactions to produce a steam enhanced catalytically cracked product 21 comprising olefins, benzene, toluene, xylene, naphtha, or combinations thereof. The olefins may include ethylene, propylene, butylene, or combinations of these. The steam enhanced catalytic cracking reactor 200 may be operated at a temperature of greater than or equal to 525° C., greater than or equal to 550° C., or even greater than or equal to 575° C. The steam enhanced catalytic cracking reactor 200 may be operated at a temperature of less than or equal to 750° C., less than or equal to 675° C., less than or equal to 650° C., or even less than or equal to 625° C. The steam enhanced catalytic cracking reactor 200 may be operated at a temperature of from 525° C. to 750° C., from 525° C. to 675° C., from 525° C. to 650° C., from 525° C. to 625° C., from 550° C. to 675° C., from 550° C. to 650° C., from 550° C. to 625° C., from 575° C. to 675° C., from 575° C. to 650° C., or from 575° C. to 625° C. The steam enhanced catalytic cracking reactor 200 may be operated at a pressure of from 1 bar to 2 bar.

The steam enhanced catalytic cracking reactor 200 may be operated in a semi-continuous manner. For example, during a conversion cycle, the steam enhanced catalytic cracking reactor 200 may be operated with the C₅₊ hydrocarbon fraction 108 and water 220 flowing to the steam enhanced catalytic cracking reactor 200 for a period of time, at which point the catalyst may be regenerated. Each conversion cycle of the steam enhanced catalytic cracking reactor 200 may be from 1 to 8 hours, from 1 to 6 hours, from 1 to 4 hours, from 2 to 8 hours, from 2 to 6 hours, or from 2 to 4 hours before switching off the feed pump 370 and the water pump 170. At the end of the conversion cycle, the flow the C₅₊ hydrocarbon fraction 108 and water 220 may be stopped and the nano-zeolite cracking catalyst may be regenerated during a regeneration cycle. In embodiments, the steam enhanced catalytic cracking system 140 may include a plurality of steam enhanced catalytic cracking reactors 200, which can be operated in parallel or in series. With a plurality of steam enhanced catalytic cracking reactors 200 operating in parallel, one or more of the steam enhanced catalytic cracking reactors 200 can continue in a conversion cycle while one or more of the other steam enhanced catalytic cracking reactors 200 are taken off-line for regeneration of the nano-zeolite cracking catalyst, thus maintaining continuous operation of the steam enhanced catalytic cracking system 140 during regeneration of one or more steam enhanced catalytic cracking reactors 200.

Referring again to FIG. 4, during a regeneration cycle, the steam enhanced catalytic cracking reactor 200 may be operated to regenerate the nano-zeolite cracking catalyst. The nano-zeolite cracking catalyst may be regenerated to remove coke deposits accumulated during the conversion cycle. To regenerate the nano-zeolite cracking catalyst, hydrocarbon gas and liquid products produced by the steam enhanced catalytic cracking process may be evacuated from the steam enhanced catalytic cracking reactor 200. Nitrogen gas may be introduced to the steam enhanced catalytic cracking reactor 200 through gas line 14 to evacuate the hydrocarbon gas and liquid products from the fixed bed steam enhanced catalytic cracking reactor 200. Nitrogen may be introduced to the steam enhanced catalytic cracking reactor 200 at gas hourly space velocity of from 10 per hour (h⁻¹) to 100 h⁻¹.

Following evacuation of the hydrocarbon gases and liquids, air may be introduced to the steam enhanced catalytic cracking reactor 200 through gas line 14 at a gas hourly space velocity of from 10 h⁻¹ to 100 h⁻¹. The air may be passed out of the steam enhanced catalytic cracking reactor 200 through line 430. While passing air through the nano-zeolite cracking catalyst in the steam enhanced catalytic cracking reactor 200, the temperature of the steam enhanced catalytic cracking reactor 200 may be increased from the reaction temperature to a regeneration temperature of from 650° C. to 750° C. for a period of from 3 hours to 5 hours. The gas produced by air regeneration of nano-zeolite cracking catalyst may be passed out of the steam enhanced catalytic cracking reactor 200 through line 430 and may be analyzed by an in-line gas analyzer connected via line 430 to detect the presence or concentration of carbon dioxide produced through decoking of the nano-zeolite cracking catalyst. Once the carbon dioxide concentration in the gases passing out of the steam enhanced catalytic cracking reactor 200 are reduced to less than 0.05% to 0.1% by weight, as determined by the in-line gas analyzer, the temperature of the steam enhanced catalytic cracking reactor 200 temperature may be decreased from the regeneration temperature back to the reaction temperature. The air flow through line 14 may be stopped. Nitrogen gas may be passed through the nano-zeolite cracking catalyst for 15 to 30 minutes. Nitrogen gas may be stopped by closing the line 14. After closing the line 14, the flow of the C₅₊ hydrocarbon fraction 108 and water 220 may be resumed to begin another conversion cycle of steam enhanced catalytic cracking reactor 200.

Still referring to FIG. 4, the steam enhanced catalytically cracked product 21 may pass out of the steam enhanced catalytic cracking reactor 200. The steam enhanced catalytically cracked product 21 may include one or more products and intermediates, such as olefins, benzene, toluene, xylene, naphtha, or combinations thereof. Olefins in the steam enhanced catalytically cracked product 21 may include ethylene, propylene, butylene, or combinations thereof.

Referring again to FIG. 1, following the steam cracking in the steam cracking zone 130 and the steam enhanced catalytic cracking in the steam enhanced catalytic cracking system 140, the steam cracked product 139 and the steam enhanced catalytically cracked product 21 may be passed to the product separator 190. In the product separator 190, catalyst may be separated from at least a portion of the steam cracked product 139 and at least a portion of the steam enhanced catalytically cracked product 21 in order to produce product streams 192, 193. In embodiments, the product separator 190 may include one or more gas-solid separators, such as one or more cyclones. Product stream 192 may include C₂-C₄ olefins. Product stream 193 may include benzene, toluene, xylenes (e.g., BTX hydrocarbons), or combinations thereof. In some embodiments, the C₂-C₄ olefins may be present in the product stream 192 in an amount of at least 30 wt. %. In or more embodiments, the benzene, toluene, and xylenes, may be present in the product stream 193 in an amount of at least 30 wt. %. In embodiments, product streams 192, 193 may be combined into a single product stream. In one or more embodiments, fuel oil may be also be included in the product streams 192, 193. Additionally, product streams 192, 193 may include naphtha and/or off gas products.

The product separator 190 may further produce one or more recycle streams from at least a portion of the steam cracked product 139 and at least a portion of the steam enhanced catalytically cracked product 21. The product separator 190 may be a distillation column or collection of separation devices that separates the steam cracked product 139, the steam enhanced catalytically cracked product 21, or both into product streams 192, 193.

In one or more embodiments, the product separator 190 may produce a first recycle stream 194, which includes at least C₁ hydrocarbons. The first recycle stream 194 may then be recycled into the methane cracking zone 120. The product separator 190 may further produce a second recycle stream 196, which includes at least C₂-C₄ paraffins. The second recycle stream 196 may then be recycled into the steam cracking zone 130. The product separator 190 may additionally produce a third recycle stream 198, which includes one or more of cracked naphtha, light cycle oil, and heavy cycle oil. The third recycle stream 198 may then be introduced to a hydrocracking zone 300.

In the hydrocracking zone 300, at least a portion of the third recycle stream 198 may be contacted by a hydrocracking catalyst. The hydrocracking zone 300 may be operated at a temperature of from 250° C. to 430° C. and a pressure of from 10 bar to 20 bar. Contact by the hydrocracking catalyst with the third recycle stream 198 may crack carbon-carbon bonds in the contents of the third recycle stream 198 and may, in particular, reduce aromatic content present in the third recycle stream 198. A wide variety of hydrocracking catalysts are contemplated as useful, and the description of some suitable hydrocracking catalysts should be construed as limiting on the presently disclosed embodiments.

The hydrocracking catalyst may include one or more metals from IUPAC Groups 5, 6, 8, 9, or 10 of the periodic table. For example, the hydrocracking catalyst may include one or more metals from IUPAC Groups 5 or 6, and one or more metals from IUPAC Groups 8, 9, or 10 of the periodic table. For example, the hydrocracking catalyst may comprise molybdenum or tungsten from IUPAC Group 6 and nickel or cobalt from IUPAC Groups 8, 9, or 10. The HDM catalyst may further include a support material, and the metal may be disposed on the support material, such as a zeolite. In one or more embodiments, the hydrocracking catalyst may include tungsten and nickel metal catalyst on a zeolite support. In embodiments, the hydrocracking catalyst may include molybdenum and nickel metal catalyst on a zeolite support.

The zeolite support material is not necessarily limited to a particular type of zeolite. However, it is contemplated that zeolites such as Y, Beta, AWLZ-15, LZ-45, Y-82, Y-84, LZ-210, LZ-25, Silicalite, or mordenite may be suitable for use in the presently described hydrocracking catalyst. For example, suitable zeolites, which can be impregnated with one or more catalytic metals such as W, Ni, Mo, or combinations thereof, are described in at least U.S. Pat. No. 7,785,563; Zhang et al., Powder Technology 183 (2008) 73-78; Liu et al., Microporous and Mesoporous Materials 181 (2013) 116-122; and Garcia-Martinez et al., Catalysis Science & Technology, 2012 (DOI: 10.1039/c2cy00309k).

In one or more embodiments, the hydrocracking catalyst may include from 18 wt. % to 28 wt. % of a sulfide or oxide of tungsten (such as from 20 wt. % to 27 wt. % or from 22 wt. % to 26 wt. % of tungsten or a sulfide or oxide of tungsten), from 2 wt. % to 8 wt. % of an oxide or sulfide of nickel (such as from 3 wt. % to 7 wt. % or from 4 wt. % to 6 wt. % of an oxide or sulfide of nickel), and from 5 wt. % to 40 wt. % of zeolite (such as from 10 wt. % to 35 wt. % or from 10 wt. % to 30 wt. % of zeolite). In other embodiments, the hydrocracking catalyst may include from 12 wt. % to 18 wt. % of an oxide or sulfide of molybdenum (such as from 13 wt. % to 17 wt. % or from 14 wt. % to 16 wt. % of an oxide or sulfide of molybdenum), from 2 wt. % to 8 wt. % of an oxide or sulfide of nickel (such as from 3 wt. % to 7 wt. % or from 4 wt. % to 6 wt. % of an oxide or sulfide of nickel), and from 5 wt. % to 40 wt. % of zeolite (such as from 10 wt. % to 35 wt. % or from 10 wt. % to 30 wt. % of zeolite).

The embodiments of the hydrocracking catalysts described may be fabricated by selecting a zeolite and impregnating the zeolite with one or more catalytic metals or by comulling zeolite with other components. For the impregnation method, the zeolite, active alumina (for example, boehmite alumina), and binder (for example, acid peptized alumina) may be mixed. An appropriate amount of water may be added to form a dough that can be extruded using an extruder. The extrudate may be dried at 80° C. to 120° C. for 4 hours to 10 hours, and then calcined at 500° C. to 550° C. for 4 hours to 6 hours. The calcined extrudate may be impregnated with an aqueous solution prepared by the compounds comprising Ni, W, Mo, Co, or combinations thereof. Two or more metal catalyst precursors may be utilized when two metal catalysts are desired. However, some embodiments may include only one of Ni, W, Mo, or Co. For example, the catalyst support material may be impregnated by a mixture of nickel nitrate hexahydrate (that is, Ni(NO₃)₂.6H₂O) and ammonium metatungstate (that is, (NH₄)₆H₂W₁₂O₄₀) if a W—Ni catalyst is desired. The impregnated extrudate may be dried at 80° C. to 120° C. for 4 hours to 10 hours, and then calcined at 450° C. to 500° C. for 4 hours to 6 hours. For the comulling method, the zeolite may be mixed with alumina, binder, and the compounds comprising W or Mo, Ni or Co (for example MoO₃ or nickel nitrate hexahydrate if Mo—Ni is desired).

It should be understood that some embodiments of the presently described methods and systems may utilize a hydrocracking catalyst that includes a mesoporous zeolite (that is, having an average pore size of from 2 nm to 50 nm). However, in other embodiments, the average pore size of the zeolite may be less than 2 nm (that is, microporous).

It should be understood that, while FIGS. 1 and 2 depict various separation apparatuses and recycle streams, products of the steam cracking zone 130, the steam enhanced catalytic cracking system 140, and/or the hydrocracking zone 300 may exit the system 100 as products in some embodiments. However, herein described are one or more embodiments depicted in FIGS. 1 and 2, which utilize recycling and separation of the one or more product streams of the steam cracking zone 130, the steam enhanced catalytic cracking system 140, and/or the hydrocracking zone 300.

Several other streams formed by the product separator 190 may be recycled in the system 100. For example, C₁ hydrocarbons may be passed to the methane cracking zone 120 via first recycle stream 194. Further, the C₂-C₄ paraffins may be passed to the steam cracking zone 130 via second recycle stream 196. Additionally, cracked naphtha, light cycle oil, and heavy cycle oil may be passed to the hydrocracking zone 300 via third recycle stream 198.

In one or more embodiments, the products of the hydrocracking zone 300 may be passed to one or more of the methane cracking zone 120, the steam cracking zone 130, or the steam enhanced catalytic cracking system 140. As is depicted in FIGS. 1 and 2, in one or more embodiments, a portion of the products of the hydrocracking zone 300 (e.g., the hydrocracked products) may be passed to the methane cracking zone 120, the steam cracking zone 130, and the steam enhanced catalytic cracking system 140. In one or more embodiments, the first hydrocracked effluent stream 302 may include at least C₁ hydrocarbons, which may be formed by the hydrocracking zone 300, and may be passed to the methane cracking zone 120 directly (not shown in FIG. 1 or 2) or indirectly by combining the first hydrocracked effluent stream 302 with the first recycle stream 194. The second hydrocracked effluent stream 304 may include at least C₂-C₄ paraffins, which may be formed by the hydrocracking zone 300, and may be passed to the steam cracking zone 130 directly (not shown in FIG. 1 or 2) or indirectly by combining the second hydrocracked effluent stream 304 with the second recycle stream 196. The third hydrocracked effluent stream 306 may include at least C₅₊ hydrocarbons, which may be formed by the hydrocracking zone 300, and passed to the steam enhanced catalytic cracking system 140 directly (not shown in FIG. 1 or 2) or indirectly by combining the third hydrocracked effluent stream 306 with the C₅₊ hydrocarbon fraction 108. As shown in FIG. 2, the third hydrocracked effluent stream 306 be separated into a lower boiling point hydrocracked effluent stream 307 and a higher boiling point hydrocracked effluent stream 308. The lower boiling point hydrocracked effluent stream 307 may include C₅₊ hydrocarbons having a T₉₅ boiling point of less than 300° C. The higher boiling point hydrocracked effluent stream 308 may include C₅₊ hydrocarbons having a T₅ boiling point of greater than or equal to 300° C. As shown in FIG. 2, higher boiling point hydrocracked effluent stream 308 may be combined with the higher boiling point fraction 110 and the lower boiling point hydrocracked effluent stream 307 may be combined with the lower boiling point fraction 109. Regardless of whether the hydrocracked effluent stream 306 is separated, it is contemplated that at least a portion of the hydrocracked effluent stream 306 may be passed to the steam enhanced catalytic cracking system 140 through one or more streams.

According to the embodiments presently disclosed, a number of advantages may be present over conventional conversion systems, which do not separate the feed stream 102 into three or more streams prior to introduction into a cracking zone such as a steam cracking zone. That is, conventional cracking units that inject, for example, the entirety of the feedstock hydrocarbon into a steam cracking zone may be deficient in certain respects as compared with the conversions system of described herein. For example, by separating the feed stream 102 prior to introduction into a steam cracking zone 130, a higher amount of light olefins and/or BTX hydrocarbons may be produced. According to the embodiments presently described, by only introducing the C₂-C₄ hydrocarbon fraction 107 to the steam cracking zone 130, the amount of lower boiling point products such as hydrogen, methane, ethylene, propylene, butadiene, and mixed butylenes may be increased, while the amount of higher boiling point products such as hydrocarbon oil can be reduced. At the same time, heavier streams, such as from the C₅₊ hydrocarbon fraction 108 and the third hydrocracked effluent stream 106, can be processed in the steam enhanced catalytic cracking system 140 into other valuable products such as benzene, toluene, xylene, C₂-C₄ olefins, or combinations thereof. According to embodiments, coking in the steam cracking zone 130 may be reduced by the elimination of materials present in the C₂-C₄ hydrocarbon fraction 107. Without being bound by theory, it is believed that injecting highly aromatic feeds into a steam cracking zone 130 may result in higher boiling point products and increased coking. Thus, it is believed that coking can be reduced and greater quantities of lower boiling point products can be produced by the steam cracking zone 130 when highly-aromatic materials are not introduced to the steam cracking zone 130 and are instead separated into at least a portion of the C₂-C₄ hydrocarbon fraction 107 by the feed separator 104.

According to one or more embodiments disclosed and described herein, capital costs may be reduced by the designs of the feed stream conversion system 100 of FIGS. 1 and 2. Since the feed stream 102 is fractionated by the feed separator 104, not all of the cracking units of the system 100 need to be designed to handle the materials contained in the C₁ hydrocarbon fraction 106, the C₂-C₄ hydrocarbon fraction 107, and the C₅₊ hydrocarbon fraction 108. It is expected that system components designed to treat materials contained in the C₅₊ hydrocarbon fraction 108 would be less expensive than system components designed to treat materials contained in the C₁ hydrocarbon fraction 106 and/or the C₂-C₄ hydrocarbon fraction 107. For example, the convection zone 132 of the steam cracking zone 130 may be designed more simply and efficiently to process the C₂-C₄ hydrocarbon fraction 107 than an equivalent convection zone that is designed to process the materials of the C₁ hydrocarbon fraction 106, the C₂-C₄ hydrocarbon fraction 107, and the C₅₊ hydrocarbon fraction 108.

According to one or more embodiments, system components such as vapor-solid separation devices and vapor-liquid separation devices may not need to be utilized between the convection zone 132 and the pyrolysis zone 134 of the steam cracking zone 130. In some conventional steam cracking units, a vapor-liquid separation device may be required to be positioned between the convection zone and the pyrolysis zone. This vapor-liquid separation device may be used to remove the higher boiling point components present in a convection zone, such as any vacuum residues. However, in some embodiments of the feed stream conversion system 100, a vapor-liquid separation device may not be needed, or may be less complex since it does not encounter higher boiling point materials such as those present in the C₂-C₄ hydrocarbon fraction 107 and/or the C₅₊ hydrocarbon fraction 108. Additionally, in some embodiments described, the steam cracking zone 130 may be able to be operated more frequently (that is, without intermittent shut-downs) caused by the processing of relatively heavy feeds. This higher frequency of operation may sometimes be referred to as increased on-stream-factor.

### EXAMPLES

The various embodiments of methods and systems for the conversion of a feedstock fuels will be further clarified by the following examples. The examples are illustrative in nature, and should not be understood to limit the subject matter of the present disclosure.

Arab Extra Light Crude Oil is processed in the system depicted in FIG. 2. Various operating parameters and conditions for each of the feed separator 104, the methane cracking zone 120, the steam cracking zone 130, the steam enhanced catalytic cracking system 140, and the hydrocracking zone 300 of system 100 are shown below in Table 1.

TABLE 1
Operating Parameters of the Components of the System

| | | | | Steam | |
|---|---|---|---|---|---|
| | | | | Enhanced | |
| | | Methane | Steam | Catalytic | Hydro- |
| | Feed | Cracking | Cracking | Cracking | cracking |
| | Separator | Zone | Zone | System | Zone |
| Temperature | 200 to | 850 to | 800 to | 600 to | 260 to |
| (° C.) | 400 | 1200 | 950 | 750 | 427 |
| Pressure | 1 to 2 | 1 to 2 | 1 to 2 | 1 to 2 | 10 to 20 |
| (bar) | | | | | |
| Residence | — | 10 | <1 | 0.1 | 0.1 hours |
| time | | seconds | second | seconds | to 7 |
| | | to 100 | | to 10 | hours |
| | | seconds | | seconds | |
| Steam to oil | — | No steam | 0.3 to 1 | 0.2 to 1 | — |
| weight ratio | | | | | |
| Catalyst | — | Carbon | — | CCC 76 to | Ni/Mo/S + |
| | | | | CCC 83 | USY |
| | | | | | Catalyst |

Products produced from each unit in the system 100 are collected and analyzed. The contents of fractions produced by the feed separator, the methane cracking zone, the steam cracking zone, and the hydrocracking zone are shown below in Table 2.

TABLE 2
Composition of Products Produced by Various Components of the System

| Feed Separator | | Methane Cracking | | Steam Cracking Zone | | Hydrocracking Zone | |
|---|---|---|---|---|---|---|---|
| Products | | Zone Products | | Products | | Products | |
| Component | wt % | Component | wt % | Component | wt % | Component | wt % |
| C₁—C₄ | 2.4 | Hydrogen | 25.0 | C₁ | 21.4 | C₁—C₅ | 3.9 |
| Hydrocarbons | | (H₂) | | Hydrocarbons + | | Hydrocarbons + | |
| C₅₊ | | | | H₂ | | H₂ | |
| Hydrocarbons | 52.7 | Carbon | 75.0 | Ethylene | 50.9 | Naphtha | 22.9 |
| with T₉₅ boiling | | | | | | | |
| point of less | | | | | | | |
| than 300° C. | | | | | | | |
| C₅₊ | 44.9 | | | Propylene | 12.3 | Distillate | 54.7 |
| Hydrocarbons | | | | | | | |
| with T₅ boiling | | | | | | | |
| point of greater | | | | | | | |
| than or equal to | | | | | | | |
| 300° C. | | | | | | | |
| | | | | Butadiene | 2.8 | Gas Oil | 17.6 |
| | | | | Mixed Butylene | 0.0 | Slurry | 1.0 |
| | | | | C₅₊ Hydrocarbons | 12.7 | | |

Various catalysts (e.g., CCC 76-CCC 83) were tested in the steam enhanced catalytic cracking system. Each of the catalysts were prepared by mixing an amount of catalyst with a nitrate solution to obtain a slurry with a 1.5 wt. % phosphorous loading. The slurry was stirred at 25° C. for 1 h and aged for an additional 1 h. After impregnation, the slurry was dried overnight at 100° C. to produce a P-Zeolite. The P-Zeolite was the calcined. After calcination, the P-Zeolites were then impregnated with metal to obtain a metal loading of 0.5 wt. % Fe, 0.5 wt. % Ce, and 1.0 wt. % La. The impregnation was performed with a volume of solution sufficient to fill the catalyst pores. After impregnation, the catalyst was then dried overnight at 100° C. and calcined at 550° C. for 8 h in static air with a slow heating rate in order to generate basic rare-earth oxide species to obtain a Fe—La—Ce P-Zeolite. The Fe—La—Ce P-Zeolites were then used to make catalyst formulations CCC 76, CCC 77, CCC 78, and CCC 79 as shown in Table 3 below:

TABLE 3
Various Zeolite Compositions for use in the Steam
Enhanced Catalytic Cracking System

| | | | Fe-La- | Fe-La- | Fe-La- | | | |
|---|---|---|---|---|---|---|---|---|
| | | | Ce-P- | Ce-P- | Ce-P- | Zr-P- | Zr-P- | Zr-P- |
| | Kaolin | Binder | ZSM-5 | Beta | USY | ZSM-5 | Beta | USY |
| Catalyst | (wt. %) | (wt. %) | (wt. %) | (wt. %) | (wt. %) | (wt. %) | (wt. %) | (wt. %) |
| CCC 76 | 40 | 20 | 40 | 0 | 0 | 0 | 0 | 0 |
| CCC 77 | 40 | 20 | 0 | 40 | 0 | 0 | 0 | 0 |
| CCC 78 | 40 | 20 | 0 | 0 | 40 | 0 | 0 | 0 |
| CCC 79 | 40 | 20 | 10 | 20 | 10 | 0 | 0 | 0 |
| CCC 80 | 40 | 20 | 5 | 15 | 20 | 0 | 0 | 0 |
| CCC 81 | 40 | 20 | 5 | 20 | 15 | 0 | 0 | 0 |
| CCC 82 | 40 | 20 | 0 | 0 | 0 | 0 | 40 | 0 |
| CCC 83 | 40 | 20 | 0 | 0 | 0 | 5 | 5 | 30 |

To prepare the CCC 76 catalyst, kaolin clay was mixed with deionized water to form a clay slurry. In a separate step, Fe-La-Ce-P-ZSM-5 was mixed with deionized water to produce a zeolite slurry. The zeolite slurry was added to the clay slurry and stirred for 5 minutes. In a separate step, Pural SB binder was mixed with deionized water and formic acid (85 wt. % concentration) to form a binder slurry. The binder slurry was then combined with the clay and zeolite slurries. Alumina gel was then added to the mixture and stirred for 1 h. The combined slurry was then sieved, spray dried, and calcined at 550° C. for 6 h. Each of the CCC 77, CCC 78, and CCC 79 were formed in similar ways, except that the zeolite composition varied as shown in Table 3. Products produced from the steam enhanced catalytic cracking system, using each of the described catalysts, are collected and analyzed. The contents of fractions produced by the steam enhanced catalytic cracking system are shown below in Table 4.

TABLE 4
Composition of Products Produced by the Steam Enhanced
Catalytic Cracking System

| | CCC | CCC | CCC | CCC | CCC | CCC | CCC | CCC |
|---|---|---|---|---|---|---|---|---|
| | 76 | 77 | 78 | 79 | 80 | 81 | 82 | 83 |
| C₅ + Conv (%) | 66.0 | 60.6 | 57.2 | 59.0 | 56.6 | 58.2 | 59.0 | 58.6 |
| C₁ + H₂ (wt. %) | 7.8 | 8.8 | 7.9 | 7.7 | 7.2 | 7.5 | 8.0 | 7.4 |
| C₂—C₄ paraffins (wt. %) | 6.0 | 5.5 | 5.3 | 5.2 | 4.8 | 5.3 | 5.5 | 5.2 |
| Ethylene (wt. %) | 18.4 | 15.3 | 15.7 | 15.8 | 14.4 | 15.0 | 16.0 | 15.1 |
| Propylene (wt. %) | 18.6 | 13.8 | 12.9 | 15.3 | 14.2 | 14.7 | 13.1 | 14.4 |
| Butylene (wt. %) | 9.1 | 10.6 | 10.1 | 9.8 | 9.9 | 10.4 | 10.1 | 10.1 |
| C₂—C₄ olefins (wt. %) | 46.1 | 39.7 | 38.7 | 40.9 | 38.5 | 40.1 | 39.2 | 39.6 |
| Naphtha (wt. %) | 25.5 | 30.4 | 31.6 | 30.0 | 32.3 | 30.4 | 31.3 | 30.2 |
| LCO (wt. %) | 5.7 | 6.3 | 7.6 | 7.6 | 7.4 | 8.0 | 6.8 | 7.6 |
| Slurry (wt. %) | 2.6 | 2.7 | 3.5 | 3.3 | 3.2 | 3.4 | 2.9 | 3.5 |
| Coke (wt. %) | 6.3 | 6.6 | 5.3 | 5.2 | 6.1 | 5.3 | 6.3 | 6.4 |

As shown in Table 4, the steam enhanced catalytic cracking system produces streams that include at least 38.5 wt. % C₂-C₄ olefins, regardless of the exact catalyst selected. Moreover, the steam enhanced catalytic cracking system has a C₅+ hydrocarbon conversion rate of at least 56.6%, regardless of the exact catalyst selected. As such, the steam enhanced catalytic cracking system is capable of producing product streams with high levels of C₂-C₄ olefins, which may then be collected from the system 100 via product stream 192. The contents of a product stream 192 when using catalyst CCC 76 in the steam enhanced catalytic cracking system are shown below in Table 5.

TABLE 5
Composition of the Product Stream

| Component | Amount (wt. %) |
|---|---|
| Ethylene | 34.0 |
| Hydrogen Sulfide | 1.3 |
| Propylene | 37.2 |
| Butylene | 21.2 |
| C₅+ Hydrocarbons (e.g., BTX) | 6.2 |
| Total | 100 |

Therefore, system 100, which incorporates a steam enhanced catalytic cracking system, is capable of producing enhanced yields of C₂-C₄ olefins and/or BTX when compared with some other known systems, such as those systems that incorporate typical fluidic catalytic cracking (FCC) units.

A first aspect of the present disclosure includes a method for processing a feed stream comprising crude oil. The method includes separating the feed stream into at least a C₁ hydrocarbon fraction, a C₂-C₄ hydrocarbon fraction, and a C₅₊ hydrocarbon fraction; methane cracking at least a portion of the C₁ hydrocarbon fraction to form a methane cracked product comprising hydrogen; steam cracking at least a portion of the C₂-C₄ hydrocarbon fraction to form a steam cracked product comprising C₂-C₄ olefins; steam enhanced catalytically cracking at least a portion of the C₅₊ hydrocarbon fraction to form a steam enhanced catalytically cracked product comprising olefins, benzene, toluene, xylene, naphtha, or combinations thereof; and passing at least a portion of the steam cracked product and at least a portion of the steam enhanced catalytically cracked product to a product separator to produce one or more product streams.

A second aspect of the present disclosure may include the first aspect, wherein the one or more product streams include a first product stream comprising C₂-C₄ olefins and a second product stream comprising benzene, toluene, xylene, and combinations thereof.

A third aspect of the present disclosure may include the first aspect and/or the second aspect, wherein the C₅₊ hydrocarbon fraction includes a lower boiling point fraction comprising C₅₊ hydrocarbons having a T₉₅ boiling point of less than 300° C. and a higher boiling point fraction comprising C₅₊ hydrocarbons having a T₅ boiling point of greater than or equal to 300° C.

A fourth aspect of the present disclosure may include any of the first through third aspects, further comprising separating at least a portion of the steam cracked product and at least a portion of the steam enhanced catalytically cracked product into at least: a first recycle stream comprising C₁ hydrocarbons; a second recycle stream comprising C₂-C₄ paraffins; and a third recycle stream comprising cracked naphtha, light cycle oil, heavy cycle oil, or combinations thereof.

A fifth aspect of the present disclosure may include the fourth aspect, further comprising methane cracking the first recycle stream.

A sixth aspect of the present disclosure may include the fourth aspect and/or the fifth aspect, further comprising steam cracking the second recycle stream.

A seventh aspect of the present disclosure may include any of the fourth through sixth aspects, further comprising hydrocracking at least a portion of the third recycle stream to form a hydrocracked product comprising C₅₊ hydrocarbons.

An eighth aspect of the present disclosure may include the seventh aspect, further comprising steam enhanced catalytically cracking at least a portion of the hydrocracked product.

A ninth aspect of the present disclosure may include the seventh aspect and/or the eighth aspect, wherein hydrocracking occurs in a hydrocracking zone having a temperature of from 250° C. to 430° C. and a pressure of from 10 bar to 20 bar.

A tenth aspect of the present disclosure may include any of the first through ninth aspects, wherein the methane cracking occurs in a methane cracking zone having a temperature of from 850° C. to 1200° C. and a pressure of from 1 bar to 2 bar.

An eleventh aspect of the present disclosure may include any of the first through tenth aspects, wherein steam cracking occurs in a steam cracking zone having a temperature of from 800° C. to 950° C. and a pressure of from 1 bar to 2 bar.

A twelfth aspect of the present disclosure may include any of the first through eleventh aspects, wherein steam enhanced catalytically cracking at least a portion of the C₅₊ hydrocarbon fraction occurs in a steam enhanced fluid catalytic cracking zone having a temperature of from 525° C. to 750° C. and a pressure of from 1 bar to 2 bar.

A thirteenth aspect of the present disclosure may include any of the first through twelfth aspects, wherein the feed stream is a crude oil having an API gravity of greater than or equal to 37° and a sulfur content of less than 1.5 wt. %, based on the total weight of the crude oil.

A fourteenth aspect of the present disclosure includes a system for processing a feed stream comprising crude oil. The system includes a separator configured to separate the crude oil into at least a C₁ hydrocarbon fraction, a C₂-C₄ hydrocarbon fraction, and a C₅₊ hydrocarbon fraction; a methane cracking zone fluidly coupled to the separator and configured to crack at least a portion of the C₁ hydrocarbon fraction; a steam cracking zone fluidly coupled to the separator and configured to crack at least a portion of the C₂-C₄ hydrocarbon fraction to form a steam cracked product; a steam enhanced catalytic cracking system fluidly coupled to the separator and configured to crack at least a portion of the a C₅₊ hydrocarbon fraction to form a steam enhanced catalytically cracked product; and a product separator fluidly coupled to at least the steam cracking zone and steam enhanced catalytic cracking system, and configured to separate at least a portion of the steam cracked product and at least a portion of the catalytically cracked product into one or more product streams.

A fifteenth aspect of the present disclosure may include the fourteenth aspect, wherein the product stream comprises benzene, toluene, xylene, C₂-C₄ olefins, or combinations thereof.

A sixteenth aspect of the present disclosure may include the fourteenth aspect and/or the fifteenth aspect, wherein the C₅₊ hydrocarbon fraction comprises a lower boiling point fraction comprising hydrocarbons having a T₉₅ boiling point of less than 300° C. and a higher boiling point fraction comprising hydrocarbons having a T₅ boiling point of higher than or equal to 300° C.

A seventeenth aspect of the present disclosure may include any of the fourteenth through sixteenth aspects, wherein the product separator is further configured to separate at least a portion of the steam cracked product and at least a portion of the catalytically cracked product into: a first recycle stream comprising C₁ hydrocarbons; a second recycle stream comprising C₂-C₄ olefins; and a third recycle stream comprising cracked naphtha, light cycle oil, heavy cycle oil, or combinations thereof.

An eighteenth aspect of the present disclosure may include the seventeenth aspect, wherein the first recycle stream is recycled into the methane cracking zone; the second recycle stream is recycled into the steam cracking zone; and the third recycle stream is recycled into the steam enhanced catalytic cracking system via a hydrocracking zone that is fluidly coupled to the product separator.

A nineteenth aspect of the present disclosure may include the eighteenth aspect, wherein the methane cracking zone is operated at a temperature of from 850° C. to 1200° C. and a pressure of from 1 bar to 2 bar; the steam cracking zone is operated at a temperature of from 800° C. to 950° C. and a pressure of from 1 bar to 2 bar; the steam enhanced catalytic cracking system is operated at a temperature of from 525° C. to 750° C. and a pressure of from 1 bar to 2 bar; and the hydrocracking zone is operated at a temperature of from 250° C. to 430° C. and a pressure of from 10 bar to 20 bar.

A twentieth aspect of the present disclosure may include any of the fourteenth through nineteenth aspects, wherein the feed stream is a crude oil having an API gravity of higher than or equal to 37° and a sulfur content of less than 1.5 wt. %, based on the total weight of the crude oil.

For the purposes of defining the present technology, the transitional phrase “consisting of” may be introduced in the claims as a closed preamble term limiting the scope of the claims to the recited components or steps and any naturally occurring impurities.

For the purposes of defining the present technology, the transitional phrase “consisting essentially of” may be introduced in the claims to limit the scope of one or more claims to the recited elements, components, materials, or method steps as well as any non-recited elements, components, materials, or method steps that do not materially affect the novel characteristics of the claimed subject matter.

The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B and C should be interpreted as also disclosing a composition “consisting of” components A, B, and C as well as a composition “consisting essentially of” components A, B, and C.

Any quantitative value expressed in the present application may be considered to include open-ended embodiments consistent with the transitional phrases “comprising” or “including” as well as closed or partially closed embodiments consistent with the transitional phrases “consisting of” and “consisting essentially of.”

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butylene may include a mixture of various isomers of butylene. It should be appreciated that the examples supply compositional ranges for various streams, and that the total amount of isomers of a particular chemical composition can constitute a range.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

1. A method for processing a feed stream comprising crude oil, the method comprising:
separating the feed stream into at least a C₁ hydrocarbon fraction, a C₂-C₄ hydrocarbon fraction, and a C₅₊ hydrocarbon fraction;
methane cracking at least a portion of the C₁ hydrocarbon fraction to form a methane cracked product comprising hydrogen;
steam cracking at least a portion of the C₂ C₄ hydrocarbon fraction to form a steam cracked product comprising C₂-C₄ olefins;
steam enhanced catalytically cracking at least a portion of the C₅₊ hydrocarbon fraction to form a steam enhanced catalytically cracked product comprising olefins, benzene, toluene, xylene, naphtha, or combinations thereof; and
passing at least a portion of the steam cracked product and at least a portion of the steam enhanced catalytically cracked product to a product separator to produce one or more product streams.

2. The method of claim 1, wherein the one or more product streams comprise:
a first product stream comprising C₂-C₄ olefins; and
a second product stream comprising benzene, toluene, xylene, and combinations thereof

3. The method of claim 1, wherein the C₅₊ hydrocarbon fraction comprises:
a lower boiling point fraction comprising C₅₊ hydrocarbons having a T₉₅ boiling point of less than 300° C.; and
a higher boiling point fraction comprising C₅₊ hydrocarbons having a T₅ boiling point of greater than or equal to 300° C.

4. The method of claim 1, further comprising separating at least a portion of the steam cracked product and at least a portion of the steam enhanced catalytically cracked product into at least:
a first recycle stream comprising C₁ hydrocarbons;
a second recycle stream comprising C₂-C₄ paraffins; and
a third recycle stream comprising cracked naphtha, light cycle oil, heavy cycle oil, or combinations thereof.

5. The method of claim 4, further comprising methane cracking the first recycle stream.

6. The method of claim 4, further comprising steam cracking the second recycle stream.

7. The method of claim 4, further comprising hydrocracking at least a portion of the third recycle stream to form a hydrocracked product comprising C₅₊ hydrocarbons.

8. The method of claim 7, further comprising steam enhanced catalytically cracking at least a portion of the hydrocracked product.

9. The method of claim 7, wherein hydrocracking occurs in a hydrocracking zone having a temperature of from 250° C. to 430° C. and a pressure of from 10 bar to 20 bar.

10. The method of claim 1, wherein the methane cracking occurs in a methane cracking zone having a temperature of from 850° C. to 1200° C. and a pressure of from 1 bar to 2 bar.

11. The method of claim 1, wherein steam cracking occurs in a steam cracking zone having a temperature of from 800° C. to 950° C. and a pressure of from 1 bar to 2 bar.

12. The method of claim 1, wherein steam enhanced catalytically cracking at least a portion of the C₅₊ hydrocarbon fraction occurs in a steam enhanced fluid catalytic cracking zone having a temperature of from 525° C. to 750° C. and a pressure of from 1 bar to 2 bar.

13. The method of claim 1, wherein the feed stream is a crude oil having an API gravity of greater than or equal to 37° and a sulfur content of less than 1.5 wt. %, based on the total weight of the crude oil.

14. A system for processing a feed stream comprising crude oil, the system comprising:
a separator configured to separate the crude oil into at least a C₁ hydrocarbon fraction, a C₂-C₄ hydrocarbon fraction, and a C₅₊ hydrocarbon fraction;
a methane cracking zone fluidly coupled to the separator and configured to crack at least a portion of the C₁ hydrocarbon fraction;
a steam cracking zone fluidly coupled to the separator and configured to crack at least a portion of the C₂-C₄ hydrocarbon fraction to form a steam cracked product;
a steam enhanced catalytic cracking system fluidly coupled to the separator and configured to crack at least a portion of the a C₅₊ hydrocarbon fraction to form a steam enhanced catalytically cracked product; and
a product separator fluidly coupled to at least the steam cracking zone and steam enhanced catalytic cracking system, and configured to separate at least a portion of the steam cracked product and at least a portion of the catalytically cracked product into one or more product streams.

15. The system of claim 14, wherein the product stream comprises benzene, toluene, xylene, C₂-C₄ olefins, or combinations thereof.

16. The system of claim 14, wherein the C₅₊ hydrocarbon fraction comprises:
a lower boiling point fraction comprising hydrocarbons having a T₉₅ boiling point of less than 300° C.; and
a higher boiling point fraction comprising hydrocarbons having a T₅ boiling point of higher than or equal to 300° C.

17. The system of claim 14, wherein the product separator is further configured to separate at least a portion of the steam cracked product and at least a portion of the catalytically cracked product into:
a first recycle stream comprising C₁ hydrocarbons;
a second recycle stream comprising C₂-C₄ olefins; and
a third recycle stream comprising cracked naphtha, light cycle oil, heavy cycle oil, or combinations thereof.

18. The system of claim 17, wherein:
the first recycle stream is recycled into the methane cracking zone;
the second recycle stream is recycled into the steam cracking zone; and
the third recycle stream is recycled into the steam enhanced catalytic cracking system via a hydrocracking zone that is fluidly coupled to the product separator.

19. The system of claim 18, wherein:
the methane cracking zone is operated at a temperature of from 850° C. to 1200° C. and a pressure of from 1 bar to 2 bar;
the steam cracking zone is operated at a temperature of from 800° C. to 950° C. and a pressure of from 1 bar to 2 bar;
the steam enhanced catalytic cracking system is operated at a temperature of from 525° C. to 750° C. and a pressure of from 1 bar to 2 bar; and
the hydrocracking zone is operated at a temperature of from 250° C. to 430° C. and a pressure of from 10 bar to 20 bar.

20. The method of claim 14, wherein the feed stream is a crude oil having an API gravity of higher than or equal to 37° and a sulfur content of less than 1.5 wt. %, based on the total weight of the crude oil.
